(19) United States
(12) Patent Application Publication
(10) Pub. No.: US 2011/0232270 A1
(43) Pub. Date: Sep. 29, 2011

(54) FUEL SYSTEM HAVING MULTI-FUNCTIONAL ELECTRIC PUMP

(76) Inventor: Joseph S. BURKITT, Edwards, IL (US)

(21) Appl. No.: 12/729,604

(22) Filed: Mar. 23, 2010

(51) Int. Cl. F01N 9/00; F04B 35/04; F16K 21/04; F16K 31/06; F02M 37/04; F01N 3/10; F01N 3/023

(52) U.S. Cl. 60/286; 417/410.1; 137/511; 137/544; 123/497; 60/303; 60/295

(57) ABSTRACT

A pump for a fuel system is provided. The pump may have a pumping mechanism and an electric motor connected to drive the pumping mechanism. The pump may also have a low-pressure inlet passage in fluid communication with the pumping mechanism, a pressurized inlet passage in fluid communication with the pumping mechanism, a first outlet passage in fluid communication with the pumping mechanism, and a second outlet passage. The pump may further have a valve movable from a first position at which the second outlet passage is blocked from the pumping mechanism, to a second position at which the second outlet passage is in fluid communication with the pumping mechanism.

### TECHNICAL FIELD

The present disclosure is directed to a fuel system and, more particularly, to a fuel system having a multi-functional electric pump.

### BACKGROUND

Operation of an internal combustion engine, for example a diesel or gasoline engine, requires that high-pressure fuel be supplied to cylinders of the engine for combustion therein that produces a mechanical power output. Current technology employs the use of a low-pressure pump and a high-pressure pump that are connected in series and mechanically driven by the engine. The low-pressure pump provides low-pressure feed to the high-pressure pump, while the high-pressure pump elevates a pressure of the fuel to a desired operating level.

During startup of an engine, it may be beneficial to prime the engine with fuel pressurized to a desired level prior to attempting to start the engine to reduce a starting time and increase a likelihood of successful starting. Fuel priming is typically performed by a manual or electric pump, as the not-yet operational engine may be unable to drive the low- and high-pressure pumps to adequately pressurize the fuel during startup.

The combustion of fuel within an engine can generate undesirable emissions, including particulate matter. Typical engine exhaust systems trap this particulate matter with a filter before the particulate matter can be discharged to the atmosphere. The use of the filter for extended periods of time, however, can cause particulate matter to build up in the filter, thereby reducing exhaust flow through the filter and subsequent engine performance. The collected particulate matter may be removed from the filter through a process called regeneration.

To initiate regeneration of the filter, the temperature of particulate matter entrained within the filter is elevated above a combustion threshold, at which the particulate matter is burned away. One way to elevate the temperature of the particulate matter is to inject relatively low-pressure fuel into the exhaust flow of the engine and ignite the injected fuel. For this purpose, a dedicated and mechanically-driven regeneration pump is commonly utilized.

As outlined above, because of the varying fuel pressure needs, flow rate needs, and driving capacity of an engine during startup, during normal operation, and during regeneration events, typical engines are equipped with four or more different fuel pumps. In addition, separate and dedicated fuel filters having varying levels of filtration are commonly associated with each of the different pumps to help ensure that the fuel passing through the pumps has been cleaned sufficiently for the intended operation. The different fuel pumps and associated filters increase a cost of the engine, consume valuable engine space, and reduce reliability of the engine.

An attempt to address one or more of the above issues is disclosed in U.S. Patent Application Publication No. 2006/0277899 A1 (the '899 publication) of Ruona published on Dec. 14, 2006. The '899 publication discloses a fuel system having a mechanical vane pump that is multi-functional. The mechanical vane pump of the '899 publication is fluidly connected to draw fuel through a single fuel strainer and deliver the fuel to an engine for both combustion and priming purposes, and to an exhaust aftertreatment device for regeneration purposes.

While the fuel system of the '899 publication may reduce the complexity of an engine's fuel system by using a single pump for multiple purposes, the fuel system may nonetheless be problematic. In particular, because the requirements for fuel pressures and flow rates can be different for engine combustion, fuel priming, and regeneration events, the single mechanical vane pump of the '899 publication may not efficiently meet all the needs of the engine. Furthermore, the single strainer included within the fuel system of the '899 publication may not provide adequate fuel filtration for each of the different fuel delivery functions performed by the single mechanical vane pump.

The fuel system of the present disclosure is directed toward improvements in the existing technology.

### SUMMARY

One aspect of the present disclosure is directed to a pump. The pump may include a pumping mechanism and an electric motor connected to drive the pumping mechanism. The pump may also include a low-pressure inlet passage in fluid communication with the pumping mechanism, a pressurized inlet passage in fluid communication with the pumping mechanism, a first outlet passage in fluid communication with the pumping mechanism, and a second outlet passage. The pump may further include a valve movable from a first position at which the second outlet passage is blocked from the pumping mechanism, to a second position at which the second outlet passage is in fluid communication with the pumping mechanism.

Another aspect of the present disclosure is directed to a fuel system for an engine. The fuel system may include a fuel source and an injector disposed in fluid communication with a combustion chamber of the engine. The fuel system may also include a first filter disposed between the fuel source and the injector, a second filter disposed upstream of the first filter and having lower efficiency than the first filter, and an aftertreatment device disposed in fluid communication with an exhaust flow of the engine. The fuel system may further include an electric pump having at least a first inlet passage fluidly connected to selectively receive fuel from a first location upstream of the first filter and downstream of the second filter, or from a second location downstream of both the first and second filters, and at least a first outlet passage connected to selectively discharge fuel to a third location upstream of the first filter and downstream of the second filter, or to the aftertreatment device.

Another aspect of the present disclosure is directed to a method of delivering fuel. The method may include selectively energizing a motor to draw a filtered flow of fuel from a low-pressure source or to receive a flow of fuel having an elevated pressure and being filtered to a higher degree than the flow of fuel drawn from the low-pressure source. The method may further include selectively directing fuel having a pressure increased by the motor to an aftertreatment device or to an engine injector.

### BRIEF DESCRIPTION OF THE DRAWINGS

FIG. 1 is a schematic illustration of an exemplary disclosed fuel system; and

FIG. 2 is a flow chart depicting an exemplary disclosed method that may be performed by the fuel system of FIG. 1.

### DETAILED DESCRIPTION

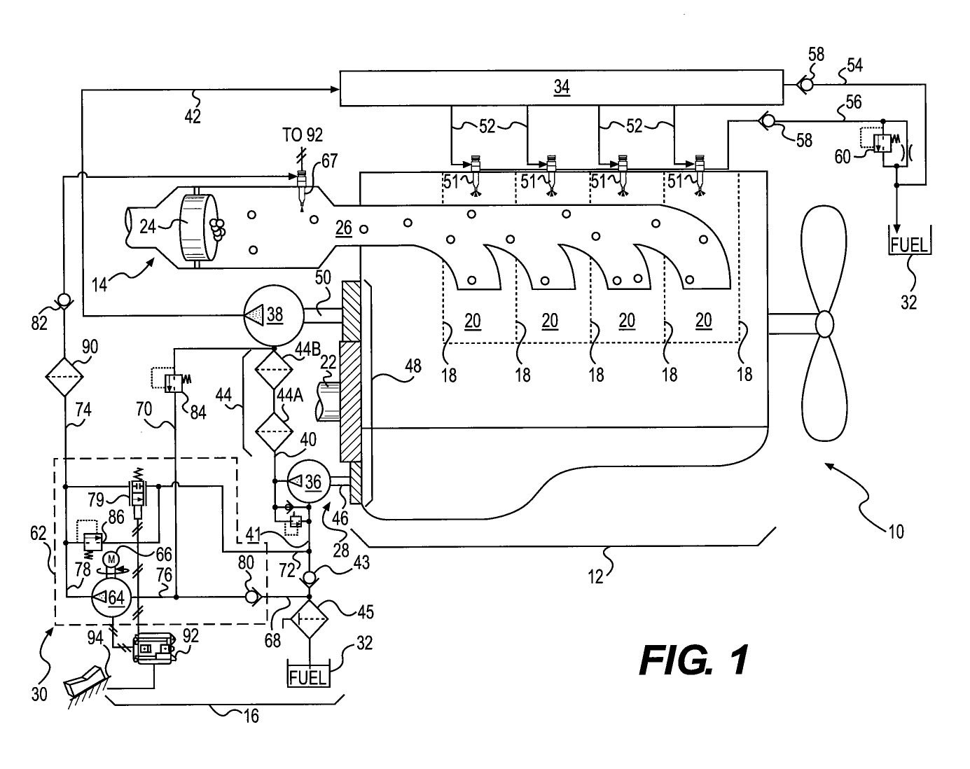

An exemplary embodiment of a power system 10 is illustrated in FIG. 1. Power system 10 may include an engine 12, an exhaust system 14, and a fuel delivery system 16. Engine 12 may receive and combust fuel supplied by fuel delivery system 16 to generate a mechanical work output and a flow of exhaust. Exhaust system 14 may receive the flow of exhaust from engine 12, condition the exhaust, and direct the conditioned exhaust to the atmosphere.

In one example, engine 12 may be an internal combustion engine having one or more cylinders 18, and a piston (not shown) slidably disposed within each cylinder 18. Each cylinder 18, together with each piston, may at least partially define a combustion chamber 20. Each piston may be connected with a crankshaft 22 so as to reciprocate within a corresponding cylinder 18 as crankshaft 22 rotates thereby expanding and contracting a volume of the associated combustion chamber 20. One skilled in the art will readily recognize that engine 12 may include any suitable number of combustion chambers 20, and that engine 12 may be any type of internal combustion engine such as, for example, a gasoline, a diesel, or a gaseous fuel-powered engine. Combustion chambers 20 may be disposed in an “in-line” configuration, a “V” configuration, or in any other conventional configuration.

Exhaust system 14 may include components that condition and direct exhaust from combustion chamber 20 to the atmosphere. For example, exhaust system 14 may include an aftertreatment device 24 disposed within an exhaust passage 26 that fluidly communicates with each combustion chamber 20. Aftertreatment device 24 may be configured to remove, reduce, and/or collect constituents of exhaust produced by engine 12. In one example, aftertreatment device 24 may embody a particulate filter having a wire mesh, a metal foam, and/or a ceramic honeycomb filtration medium. As the flow of exhaust from engine 12 passes through the filtration medium, particulate matter, for example unburned hydrocarbons, may impinge against and be blocked by the filtration medium.

Over time, the collected particulate matter may build up within aftertreatment device 24 and the filtration medium may become saturated. If unaccounted for, this buildup of matter could reduce exhaust flow through the filtration medium and subsequent engine performance. For this reason, aftertreatment device 24 and/or exhaust passing through aftertreatment device 24 may be selectively heated to promote regeneration of the filtration medium. As heated exhaust flows through aftertreatment device 24, a part or all of the particulate matter trapped therein may undergo an exothermic reaction and be reduced. This process may be know as active regeneration, as the temperature of the exhaust and/or aftertreatment device 24 may be artificially raised to initiate and/or maintain combustion of the trapped particulate matter. In the disclosed embodiment, aftertreatment device 24 and/or the exhaust passing through aftertreatment device 24 may be heated through combustion of fuel that has been directed into the exhaust flow of engine 12.

Fuel delivery system 16 may include components that cooperate to deliver fuel into each combustion chamber 20 of engine 12 and separately into exhaust passage 26 upstream of aftertreatment device 24. In particular, fuel delivery system 16 may include a primary supply arrangement 28 and an auxiliary supply arrangement 30. Primary supply arrangement 28 may be configured to provide fuel to engine 12 during normal operation (i.e., during engine operation that does not correspond with a priming event or a regeneration event), while auxiliary supply arrangement 30 may be configured to selectively provide fuel to engine 12 during a priming event and to exhaust system 14 during a regeneration event.

Primary supply arrangement 28 may be a common rail-type arrangement having a low-pressure tank 32 configured to hold a supply of fuel, and one or more pumping devices that draw fuel from tank 32, increase a pressure of the fuel from tank 32, and direct one or more streams of pressurized fuel to a common rail 34. In one example, the pumping devices may include a low-pressure source 36 and a high-pressure source 38 disposed in series and fluidly connected by way of a fuel line 40. Low-pressure source 36 may embody a transfer pump that provides low-pressure feed to high-pressure source 38. High-pressure source 38 may receive the low-pressure feed and increase the pressure of the fuel to the range of about 30-300 MPa. Low-pressure source 36 may be connected to tank 32 by way of a fuel line 41, while high-pressure source 38 may be connected to common rail 34 by way of a fuel line 42. A check valve 43 may be located within fuel line 41, upstream of low-pressure source 36 to help ensure a unidirectional flow of fuel to common rail 34. One or more fuel filtering elements 44, such as a primary filter 44A and a secondary filter 44B, may be disposed within fuel line 40 in series relation to remove debris and/or water from the fuel pressurized by primary supply arrangement 28. Primary and secondary filters 44A, 44B may be substantially identical and have a rated filtration of for example, about 4 μm. In some embodiments, an additional filter 45 having a lower efficiency rating may also be utilized and located upstream of primary and secondary filters 44A, 44B, if desired. For example, filter 45 may be located within fuel line 41 and have a rated filtration of, for example, about 10 μm and thus remove less material from a given fuel flow than either of primary and secondary filters 44A, 44B. It is contemplated that filter 45 may additionally function as a fuel/water separator, if desired.

One or both of low- and high-pressure sources 36, 38 may be operably connected to engine 12 and mechanically driven by crankshaft 22. Low- and/or high-pressure sources 36, 38 may be connected with crankshaft 22 in any manner readily apparent to one skilled in the art where a rotation of crankshaft 22 will result in a corresponding driving rotation of an associated pump driveshaft. For example, a driveshaft 46 of low-pressure source 36 is shown in FIG. 1 as being connected to crankshaft 22 through a gear train 48, while high-pressure source 38 is shown as being connected to crankshaft 22 by way of a driveshaft 50 and gear train 48. It is contemplated, however, that one or both of low- and high-pressure sources 36, 38 may alternatively be driven electrically, hydraulically, pneumatically, or in any other appropriate manner. It is further contemplated that primary supply arrangement 28 may alternatively embody another type of fuel system such as, for example, a mechanical unit fuel injector system where the pressure of the injected fuel is generated or enhanced within individual injectors without the use of a high-pressure source, if desired.

Common rail 34 may distribute fuel that has been pressurized by primary supply arrangement 28 to a plurality of engine injectors 51 via individual passages 52. Each engine injector 51 may be disposed in fluid communication with an associated combustion chamber 20 and be operable to inject fuel into the associated combustion chamber 20 at predetermined timings, pressures, and quantities to affect a power output and/or exhaust emissions of engine 12. Each engine injector 51 may embody any type of fuel injection device such as, for example, a mechanically actuated-mechanically controlled injector, an electronically actuated-electronically controlled injector, a mechanically actuated-electronically controlled injector, a digitally controlled fuel valve, or any other type of fuel injector known in the art. In one embodiment, common rail 34 and each engine injector 51 may be connected to return surplus fuel to tank 32 via return lines 54 and 56, respectively. One or more check valves 58 and/or pressure regulators 60 may be located within return lines 54, 56 to regulate fuel pressures within common rail 34 and engine injectors 51, if desired.

Auxiliary supply arrangement 30 may include a pump 62 that draws in a flow of low-pressure fuel, receives a flow of pressurized fuel, increases a pressure of the drawn-in and received flows of fuel, and selectively directs one or more pressurized streams of fuel to an exhaust injector 67 during a regeneration event or to engine injectors 51 during a priming event, as will be explained in more detail below. For these purposes, pump 62 may be equipped with a pumping mechanism 64 driven by an electric motor 66 to increase a pressure of fuel passing through pumping mechanism 64, a low-pressure inlet passage 68, a pressurized inlet passage 70, a priming outlet passage 72, and a regeneration outlet passage 74. Low-pressure inlet passage 68 may be connected to fuel line 41 to direct a flow of low-pressure fuel drawn from a location downstream of filter 45 and upstream of primary and secondary filters 44A, 44B to a low-pressure galley 76 of pumping mechanism 64. Pressurized inlet passage 70 may be connected to fuel line 40 to direct a flow of fuel that has already been pressurized by low-pressure source 36 and received from a location downstream of both primary and secondary filters 44A, 44B to low-pressure galley 76. Priming outlet passage 72 may be connected to fuel line 41 to direct pressurized fuel from a high-pressure galley 78 of pumping mechanism 64 into fuel line 41 at a location downstream of filter 45 and low-pressure inlet 68, and upstream of low-pressure source 36. Regeneration outlet passage 74 may be connected to direct pressurized fuel from high-pressure galley 78 to exhaust injector 67.

A control valve 79 may be located within priming outlet passage 72. Control valve 79 may be a solenoid-operated, spring-biased valve that is movable between a first position associated with operation of engine 12 during a regeneration event, and a second position associated with operation of engine 12 during a priming event. When in the first or regeneration position, control valve 79 may block fuel flow from pumping mechanism 64 to fuel line 41 via priming outlet passage 72. When in the second or priming position, control valve 79 may allow fuel flow from pumping mechanism 64 to fuel line 41 via priming outlet passage 72. In this manner, operation of pumping mechanism 64, when control valve 79 is in the regeneration position, may force pressurized fuel exiting pumping mechanism 64 through regeneration outlet passage 74 to exhaust injector 67 in preparation for the regeneration event. And, operation of pumping mechanism 64 when control valve 79 is in the priming position, may force pressurized fuel exiting pumping mechanism 64 through priming outlet passage 72 to fuel line 41 during a priming event. From fuel line 41, the fuel pressurized by pumping mechanism 64 during the priming event may be directed to engine injectors 51 in preparation for a subsequent startup of engine 12.

One or more check valves and/or pressure regulators may be associated with the inlet and outlet passages of pump 62. For example, a check valve 80 may be disposed within low-pressure inlet passage 68 to help ensure unidirectional fuel flow from fuel line 41 to low-pressure galley 76. Similarly, a check valve 82 may be located within regeneration outlet passage 74 to help ensure unidirectional fuel flow from high-pressure galley 78 to exhaust injector 67. A pressure regulator 84 may be located within pressurized inlet passage 70 to help provide for desired pressure levels within pressurized inlet passage 70 and low-pressure galley 76. Another pressure regulator 86 may be located within a balancing passage 88 that connects high-pressure galley 78 with a portion of priming outlet passage 72 at a location downstream of control valve 79 (i.e., pressure regulator 86 may be in parallel with control valve 79) to help provide for desired pressure levels within high-pressure galley 78 and priming outlet passage 72.

In one embodiment, an additional filter 90 may be located in regeneration outlet passage 74. For example, filter 90 may be located between check valve 82 and exhaust injector 67. Filter 90 may be have a filter rating of, for example, about 4 μm.

A controller 92 may be associated with auxiliary supply arrangement 30 to facilitate fuel supply during regeneration and priming events. Controller 92 may receive input indicative of a desired regeneration or priming event, and selectively regulate operation of control valve 79, motor 66, and/or exhaust injector 67 based on the input. The input triggering regulation by controller 92 may be automatically generated based on one or more monitored conditions of engine 12 and/or manually generated by operator manipulation of a switch 94 or other input device.

Controller 92 may embody a single or multiple microprocessors, field programmable gate arrays (FPGAs), digital signal processors (DSPs), etc. that include a means for controlling an operation of power system 10 in response to signals received from switch 94 and/or from a general power system processor. Numerous commercially available microprocessors can be configured to perform the functions of controller 92. It should be appreciated that controller 92 could readily embody a microprocessor separate from a processor that controlls other non-exhaust related power system functions, or that controller 92 could be integral with the general power system processor and be capable of controlling numerous power system functions and modes of operation. If separate from the general power system processor, controller 92 may communicate with the general power system processor via data links or other methods. Various other known circuits may be associated with controller 92, including power supply circuitry, signal-conditioning circuitry, actuator driver circuitry (i.e., circuitry powering solenoids, motors, or piezo actuators), communication circuitry, and other appropriate circuitry.

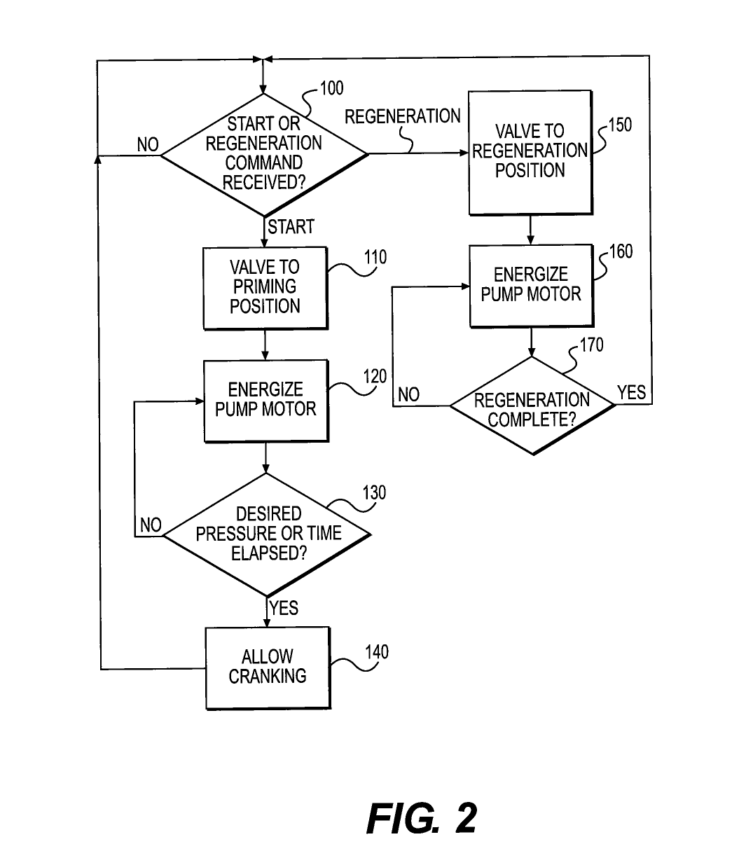

FIG. 2 illustrates an exemplary method that may be performed by power system 10. This method will be explained in more detail in the follow section to better illustrate the disclosed system an its operation.

### INDUSTRIAL APPLICABILITY

The fuel delivery system of the present disclosure has wide application in a variety of engine types including, for example, diesel engines, gasoline engines, and gaseous fuel-powered engines. The disclosed fuel delivery system may separately deliver fuel to an engine for combustion via mechanically-driven transfer and primary pumps, and for priming and exhaust aftertreatment purposes via an electric pump. During a priming event, fuel may be pressurized by the electric pump before passing through high-efficiency filters also used during normal engine operation. During a regeneration event, fuel may first pass through the high-efficiency filters before being pressurized by the electric pump. In this manner, the fuel used for any purpose may always pass through and be appropriately cleaned by existing high-efficiency filters, without the requirement for additional priming- or aftertreatment-dedicated high-efficiency filters. As a result, the disclosed fuel delivery system may provide clean fuel to multiple systems in an efficient and cost-effective manner.

Operation of fuel delivery system 16 will now be described with reference to FIGS. 1 and 2. During normal engine operation (i.e., during engine operation after startup that does not correspond with a regeneration event), fuel may be drawn from low-pressure tank 32 by low-pressure source 36, through fuel line 41 and filter 45, and past check valve 43. During this time, fuel line 41 may function as a bypass passage to allow low-pressure fuel from tank 32 to bypass auxiliary pumping arrangement 30. As the fuel from low-pressure tank 32 passes through low-pressure source 36, the fuel may be pressurized to a first level, and then directed through filtering elements 44 to high-pressure source 36, where the pressure of the fuel may be increased even more. The highly-pressurized fuel may then be passed to common rail 34 via fuel line 42, and from common rail 34, distributed to individual fuel injectors 51 via passages 52. Fuel injectors 51 may be controlled to inject desired amounts of the pressurized fuel into combustion chambers 20 at precise timings. Surplus fuel delivered to common rail 34 and/or to injectors 51 may be returned to tank 32 by way of fuel return lines 54 and 56, respectively.

The combustion of fuel within engine 12 may produce a mechanical work output in the form of crankshaft rotation, and a flow of exhaust that is directed through exhaust passage 26 to aftertreatment device 24. The rotation of crankshaft 22 may drive both low- and high-pressure sources 36, 38 to pressurize additional fuel. Particulates entrained in the exhaust passing through aftertreatment device 24 may be blocked and retained therein.

As can be seen from FIG. 2, operation of auxiliary supply arrangement 30 may begin when a signal associated with either engine startup or filter regeneration is received by controller 92. An engine startup signal may be automatically generated when, for example, an operator turns a key in an attempt to start engine 12. Alternatively, switch 94 or another similar input device may be manually manipulated, thereby generating a signal indicating that fuel priming should commence in anticipation of a startup sequence. During a priming event, engine 12 may be completely non-operational or, alternatively, engine 12 may be cranking in an attempt to become operational. A filter regeneration signal may be automatically generated based on an elapsed operational time period, a pressure measured across aftertreatment device 24, a temperature of exhaust entering or leaving aftertreatment device 24, or based on any other measured or assumed engine- or exhaust-related parameter. Alternatively, an operator may manually produce the filter regeneration signal by, for example, depressing switch 94 or manipulating another input device.

Controller 92 may receive the engine startup and filter regeneration signals described above, and responsively regulate operation of auxiliary supply arrangement 30 (Step 100). For example, if a signal indicative of engine startup is received, controller 92 may energize control valve 79 to move control valve 79 to the priming position, at which priming outlet passage 72 may be fluidly communicated with pumping mechanism 64 (Step 100: Start). It is contemplated that control valve 79 may alternatively or additionally be manually moved to the priming position to thereby initiate the priming event, if desired. If no signal is received by controller 92, control may continue to loop through step 100 (Step 100: No).

After control valve 79 has been moved to the priming position and while engine 12 is either non-operational or cranking, controller 92 may energize motor 66 to drive pumping mechanism 64 and thereby increase a pressure of fuel passing through pumping mechanism 64 (Step 120). During the priming event, low- and high-pressure sources 36, 38 may or may not be active. With control valve 79 in the priming position and motor 66 energized, a flow of low-pressure fuel may be drawn by pumping mechanism 64 from low-pressure tank 32 through filter 45, into low-pressure inlet passage 68 and past check valve 80 to low-pressure galley 76. From low-pressure galley 76, the fuel may pass through pumping mechanism 64, be pressurized, and continue through high-pressure galley 78 and control valve 79 to priming outlet passage 72. The pressurized fuel may then enter fuel line 41 and pass through low-pressure source 36 to filtering elements 44. After passing through filtering elements 44, the pressurized fuel may pass through high-pressure source 38, fuel line 42, common rail 34, and individual passages 52, to engine injectors 51. This operation may continue until a desired pressure within fuel delivery system 16 has been achieved or until a desired period of time has elapsed, the desired period of time corresponding to a desired pressure. Alternatively, the priming operation may continue until manually terminated, if desired.

Once controller 92 has determined that the desired period of time has elapsed or that the desired fuel pressure within fuel delivery system 16 has been achieved (Step 130: Yes), controller 92 may then stop priming and control may return to step 100. It is contemplated, however, that controller 92 may additionally be configured to allow and/or initiate cranking of engine 12 following completion of step 130, if desired (Step 140). In this situation, priming may continue during engine cranking, as needed, until engine 12 has been successfully started.

Check valve 82 may help ensure that fuel pressurized by pumping mechanism 64 during a priming event may only be delivered to engine injectors 51 (i.e., that fuel may not be delivered to exhaust injector 67). Specifically, check valve 82 may remain closed during a priming event, as the pressures achieved during the priming event may be less than a closing spring bias of check valve 82. In addition or alternatively, exhaust injector 67 may be deactivated during a priming event such that fuel, even if allowed to pass check valve 82, may be trapped within regeneration outlet passage 74 during the priming event. It is contemplated, however, that fuel may be directed both to engine injectors 51 and to exhaust injector 67 during a priming event, if desired.

The fuel pressurized by pumping mechanism 64 during the priming event may be sufficiently clean without requiring additional and dedicated priming filters. In particular, all fuel pressurized by pumping mechanism 64 during the priming event may subsequently be passed through high-efficiency filtering elements 44, which may also be used during normal operation of engine 12, before the fuel is received by engine injectors 51. This arrangement may allow for reduced component cost, system complexity, and space consumption.

If, at step 100, controller 92 receives a regeneration signal (Step 100: Regeneration), controller 92 may de-energize control valve 79 (if previously energized) to move control valve 79 to the regeneration position at which priming outlet passage 72 may be blocked to inhibit fuel that has been pressurized by pumping mechanism 64 from passing to primary supply arrangement 28 (Step 150). After control valve 79 has been moved to the priming position and while engine 12 is fully operational, controller 92 may energize motor 66 to drive pumping mechanism 64 and thereby increase a pressure of fuel passing through pumping mechanism 64 (Step 160). At this time, a flow of pressurized fuel may be received by pumping mechanism 64 from downstream of low-pressure source 36 and filtering elements 44. The pressurized fuel may be directed into pressurized inlet passage 70, and past pressure regulator 84 to low-pressure galley 76. From low-pressure galley 76, the fuel may pass through pumping mechanism 64, be further pressurized, and enter high-pressure galley 78. From high-pressure galley 78, the fuel may enter regeneration outlet passage 74 and pass through filter 90 and check valve 82 to exhaust injector 67. Exhaust injector 67 may then be controlled according to pre-programmed instructions such that the pressurized fuel is injected and combusted and the filtration medium of aftertreatment device 24 is thereby sufficiently regenerated. The regeneration operation of pumping mechanism 64 may continue until a desired condition of aftertreatment device 24 has been achieved or until a desired period of time has elapsed, the desired period of time corresponding to the desired condition (Step 170: No). After completion of step 170, control may return to step 100 (Step 170: Yes).

The fuel pressurized by pumping mechanism 64 during the regeneration event may also be sufficiently clean without requiring additional and dedicated regeneration filters. In particular, all fuel pressurized by pumping mechanism 64 during the regeneration event may first be passed through filtering elements 44, which may also be used during normal operation of engine 12, before the fuel is received by pumping mechanism 64 and passed to exhaust injector 67. As discussed above, this arrangement may allow for reduced component cost, system complexity, and space consumption.

It is contemplated that the fuel pressure and/or the fuel flow rate produced by pumping mechanism 64 during the regeneration event may be different than those produced during a priming event, if desired. For example, motor 66 may drive pumping mechanism 64 with a speed and/or a torque that corresponds with the current event. In this manner, operation of auxiliary supply arrangement 30 may be tailored to the specific needs of power system 10 during the different operational events.

It will be apparent to those skilled in the art that various modifications and variations can be made in the fuel delivery system of the present disclosure without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A pump, comprising:
a pumping mechanism;
an electric motor connected to drive the pumping mechanism;
a low-pressure inlet passage in fluid communication with the pumping mechanism;
a pressurized inlet passage in fluid communication with the pumping mechanism;
a first outlet passage in fluid communication with the pumping mechanism;
a second outlet passage; and
a control valve movable from a first position at which the second outlet passage is blocked from the pumping mechanism, to a second position at which the second outlet passage is in fluid communication with the pumping mechanism.

2. The pump of claim 1, further including a check valve disposed within the low-pressure inlet passage.

3. The pump of claim 2, further including a pressure regulator located between the pumping mechanism and the second outlet passage, in parallel with the control valve.

4. The pump of claim 1, further including:
a bypass passage fluidly connecting the low-pressure inlet passage with the second outlet passage and bypassing the pumping mechanism; and
a check valve disposed within the bypass passage.

5. The pump of claim 4, wherein the pressurized inlet passage is fluidly connected downstream of the bypass passage.

6. The pump of claim 1, further including a first filter and water separator at the low-pressure inlet passage.

7. The pump of claim 6, further including a second filter located at the pressurized inlet passage, wherein the second filter has a higher filter rating than the first filter and water separator.

8. A fuel system for an engine, comprising:
a fuel supply;
an engine injector disposed in fluid communication with a combustion chamber of the engine;
a first filter disposed between the fuel supply and the engine injector;
a second filter disposed upstream of the first filter and having lower efficiency than the first filter;
an aftertreatment device disposed in fluid communication with an exhaust flow of the engine; and
an electric pump having:
at least a first inlet passage fluidly connected to selectively receive fuel from a first location upstream of the first filter and downstream of the second filter, or from a second location downstream of both the first and second filters; and
at least a first outlet passage connected to selectively discharge fuel to a third location upstream of the first filter and downstream of the second filter, or to the aftertreatment device.

9. The fuel system of claim 8, further including a primary pump fluidly connected downstream of both the first and second filters and upstream of the engine injector.

10. The fuel system of claim 9, further including a transfer pump fluidly connected between the first and second filters, downstream of the first location.

11. The fuel system of claim 8, further including a valve selectively movable from an open position corresponding to a priming event during which fuel from the electric pump is directed to the third location, to a closed position corresponding to an exhaust injection event during which fuel from the electric pump is directed to only the aftertreatment device.

12. The fuel system of claim 11, wherein the at least a first inlet passage receives fuel from only the first location during the priming event and from only the second location during the exhaust injection event.

13. The fuel system of claim 11, wherein:
the at least a first outlet passage includes:
a first outlet passage in fluid communication with the third location; and
a second outlet passage in fluid communication with the aftertreatment device; and
the valve is fluidly connected between the first and second outlet passages.

14. The fuel system of claim 8, wherein the second filter includes a water separator.

15. The fuel system of claim 8, further including:
a first check valve fluidly connected between the first location and the at least one inlet passage; and
a second check valve fluidly connected between the first and second filters.

16. The fuel system of claim 15, further including a pressure regulator fluidly connected between the second location and the at least one inlet passage.

17. The fuel system of claim 8, further including a third filter substantially identical to the first filter and disposed between the fuel supply and the engine injector.

18. A method of delivering fuel, comprising:
selectively energizing a motor to:
draw a filtered flow of fuel from a low-pressure supply or receive a flow of fuel having an elevated pressure and being filtered to a higher degree than the flow of fuel drawn from the low-pressure supply; and
increase a pressure of the flow of fuel drawn from the low-pressure supply or the received flow of fuel; and
selectively directing fuel having a pressure increased by operation of the motor to an aftertreatment device or to an engine injector.

19. The method of claim 18, further including receiving a signal to initiate one of a priming event and a regeneration event, wherein the selective energizing and the selective directing are performed based on the received signal.

20. The method of claim 18, wherein:
only the flow of fuel drawn from the low-pressure supply is directed to the engine injector during the priming event; and
only the received flow of fuel having the elevated pressure is directed to the aftertreatment device during the regeneration event.
